(19) United States
(12) Patent Application Publication
(10) Pub. No.: US 2017/0024764 A1
(43) Pub. Date: Jan. 26, 2017

(54) Evaluating Content Items For Presentation To An Online System User Based In Part On Content External To The Online System Associated With The Content Items

(71) Applicant: Facebook, Inc., Menlo Park, CA (US)

(72) Inventors: Jonathan Mooser, Mountain View, CA (US); Yi Tang, Mountain View, CA (US); Justin Paul Parrella, San Francisco, CA (US); Shuo Li, Mountain View, CA (US); Kai Du, San Jose, CA (US)

(21) Appl. No.: 14/806,310

(22) Filed: Jul. 22, 2015

(51) Int. Cl. G06Q 30/02; G06F 17/30

(52) U.S. Cl. CPC G06Q 30/0254; G06F 17/3053; G06F 17/30867; G06Q 30/0275; G06Q 30/0277

(57) ABSTRACT

An online system receives advertisement (“ad”) requests for presentation to online system users. An ad request may include an identifier of a landing page identifying a source external to the online system from which content is retrieved and presented to a user who interacts with content from the ad request. The online system determines a quality score for the source based on a frequency with which online system users request content from the source via the online system and various types of interactions by online system users with content associated with the source that is presented by the online system (e.g., interactions with content associated with the source indicating user interest in the source). Based on the quality score for the source, the online system modifies a score for the ad request used by the online system to determine whether to present content form the ad request to a user.

### BACKGROUND

This disclosure generally relates to content presented by an online system, and more particularly to evaluating content items for presentation to a user based on a measure of quality of content external to the online system associated with the content items.

An online system, such as a social networking system, allows its users to connect to and to communicate with other online system users and with objects on the online system. Users may create profiles on an online system that are tied to their identities and include information about the users, such as interests and demographic information. The users may be individuals or entities such as corporations or charities. Because of the increasing popularity of online systems and the significant amount of user-specific information maintained by online systems, an online system allows users to easily communicate information about themselves to other users and share content with other users. For example, an online system provides content items to a user describing actions performed by other users of the online system who are connected to the user.

Additionally, entities (e.g., a business) sponsor presentation of content items (“sponsored content” or “sponsored content items”) via an online system to gain public attention for the entity's products or services, or to persuade online system users to take an action regarding the entity's products or services. Many online systems receive compensation from an entity for presenting online users with certain types of sponsored content items provided by the entity. Frequently, online systems charge an entity for each presentation of sponsored content to an online system user (e.g., each “impression” of the sponsored content) or for each interaction with sponsored content by an online system user (e.g., each “conversion”). For example, an online system receives compensation from an entity each time a content item provided by the entity is displayed to a user on the online system or each time a user presented with the content item requests additional information about a product or service described by the content item by interacting with the content item (e.g., requests a product information page by interacting with the content item).

Sponsored content items presented by an online system may be associated with a landing page that identifies content external to the online system for presentation to an online system user. For example, a sponsored content item may include a network address (e.g., a uniform resource locator) identifying the landing page, and when an online system user interacts with the advertisement via a client device, the client device retrieves content from the network address and presents the content in an application (e.g., a browser). Typically, the sponsored content item includes content representing the content included on a landing page. Thus, users interested in content presented by the sponsored content item interact with the sponsored content item to obtain additional information from the associated landing page about the content presented by the sponsored content item. However, landing pages may provide varying types of information to a user. For example, certain landing pages may provide minimal information describing content from a sponsored content item, while other landing pages may provide information unrelated to content presented by a sponsored content item. When a user interacts with a sponsored content item and is presented with content from a landing page that is of little relevance or interest to the user, the user is less likely to interact with other sponsored content items, which reduces interaction by the user with content presented by the online system and reduces potential revenue to the online system from presenting sponsored content items.

### SUMMARY

An online system receives an advertisement request (“ad request”) from an advertiser including a bid amount and an advertisement for presentation to a user. Additionally, the ad request includes an identifier landing page identifying a source external to the online system, and when the user interacts with the advertisement (e.g., selects the advertisements), content from the landing page is retrieved and presented to the user. For example, the identifier of the landing page is a network address and content is retrieved from the network address for presentation when the user interacts with the advertisement. The online system may maintain ad requests received from various sources or may retrieve ad requests maintained by third party systems.

When a user of the online system requests content from the online system, the online system identifies ad requests eligible for presentation to the user, as well as other content items eligible for presentation to the user. An ad request eligible for presentation to the user includes at least a threshold number of targeting criteria satisfied by characteristics of the user, or it may not include targeting criteria. Similarly, a content item eligible for presentation to the user has one or more characteristics, such as an association with another user or object connected to the user via the online system. When the online system identifies an ad request eligible for presentation to the user, the online system generates a score for the ad request based on a likelihood of the user interacting with the advertisement from the ad request and a bid amount included in the ad request. The online system performs one or more selection processes on ad requests and content items eligible for presentation to the user to select content for presentation to the user. A selection process may rank ad requests based on their associated scores and select ad requests having at least a threshold position in the ranking or select ad requests having at least a threshold score for presentation to the user.

When an ad request eligible for presentation to the user includes an identifier of a landing page that identifies a source external to the online system, the online system modifies the score of the ad request based at least in part on a quality score for the source external to the online system. For example, if the identifier of the landing page includes a network address of a domain different than a domain of the online system, the online system determines a quality score of the domain different than the domain of the online system. To determine the quality score for the source external to the online system, the online system retrieves stored actions of online system users and identifies a frequency with which online system users access the source external to the online system from the online system. For example, the online system determines a number of times online system users have requested content from the source external to the online system while interacting with the online system within a time interval or determines an average frequency with which online system users have requested content from the source external to the online system while interacting with the online system. Additionally, from the stored actions, the online system identifies one or more types of interactions by online system users with content associated with the source external to the online system and determines a quality score for the source external to the online system based on the identified types of interactions and the frequency with which online system users access the source external to the online system from the online system. For example, the online system identifies types of interactions by users indicating an interest in content associated with the source provided to the online system. Example types of interactions indicating an interest in content associated with the source include: users expressing a preference for a content item presented by the online system and associated with the source, users sharing a content item presented by the online system and associated with the source with one or more additional users, users providing a comment associated with a content item associated with the source, and users establishing connections with one or more objects maintained by the online system and associated with the source. In some embodiments, the online system determines the quality score for the source as a ratio of a value based on the identified types of interactions with content associated with the source external to the online system to the frequency with which online system users access the source external to the online system from the online system. For example, the online system associates different weights with different types of interactions and generates the value by applying weights to numbers of the different types of interactions or frequencies with which users perform the different types of interactions and combining the results from application of the weights. Additionally, the online system may account for types of interactions indicating a lack of interest in content associated with the source when determining the quality score for the source external to the online system.

Based on the quality score for the source external to the online system, the online system modifies the score for the ad request including the identifier of the landing page identifying the source. For example, if the quality score for the source equals or exceeds a threshold value, the online system increases the score for the ad request. As another example, if the quality score for the source is less than alternative threshold value, the online system decreases the score for the ad request. In some embodiments, the online system compares the quality score to various ranges, each associated with amounts by which to modify the score for the ad request, identifies a range including the quality score, and modifies the score for the ad request by the amount associated with the identified range. Alternatively, the online system modifies the score by an amount that is a function of the quality score for the source (e.g., an amount that is proportional to the quality score for the source). In some embodiments, the online system modifies scores associated with multiple ad requests including an identifier of a landing page identifying the source external to the online system (e.g., each ad request including an identifier of a landing page within a domain of the source). Alternatively, the online system modifies scores associated with additional ad requests including an identifier of a landing page identifying the source external to the online system and having a threshold number or threshold percentage of characteristics matching characteristics of the ad request including the identifier of the landing page identifying the source.

The online system includes the ad request and its modified score in the one or more selection processes along with other ad requests or content items to identify content for presentation to the user. Using the modified score for the ad request in the selection process allows the online system to account for the quality of content from the source external to the online system when selecting content for presentation to the user. Hence, an ad request associated with a landing page identifying a source external to the online system having a higher quality score is more likely to be selected for presentation to the user because the score for the ad request is increased based on the higher quality score. This improves user interaction with content selected by the online system, while increasing potential revenue to the online system by presenting users with advertisements from ad requests associated with sources with which users are more likely to access by accessing the advertisements.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for modifying a score of an advertisement request based on a quality score of a source external to an online system associated with a landing page of the advertisement request, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

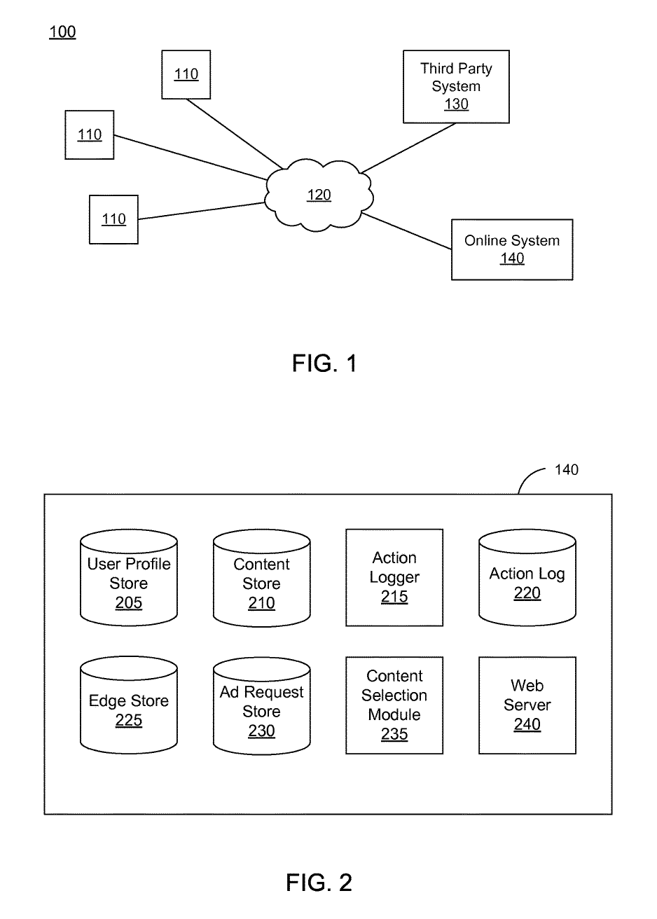

FIG. 1 is a high level block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisement requests, content, description of actions performed by social networking system users via the third party system 130, or information about an application provided by the third party system 130. Additionally, a third party system 130 may be associated with a domain differing from a domain associated with the online system 140.

FIG. 2 is an example block diagram of an architecture of the online system 140. The online system 140 shown in FIG. 2 includes a user profile store 205, a content store 210, an action logger 215, an action log 220, an edge store 225, an advertisement request (“ad request”) store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content, also referred to as an “advertisement,” and a bid amount. The advertisement is text, image, audio, video, or any other suitable data presented to a user. In various embodiments, the ad request also includes an identifier of a landing page specifying a network address to which a user is directed when the advertisement is accessed. Hence, the identifier of the landing page identifies a source from which content is retrieved and presented by a client device if a user interacts with the advertisement in the ad request. The source identified by the identifier of the landing page may be associated with a domain different from a domain associated with the online system 140. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information (e.g. demographics), edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the viewing user. For example, the content selection module 235 determines scores for various content items based on measures of relevance of the content items to the user determined from characteristics associated with the user by the social networking system 140 and the user's affinity for different content items. Based on the scores, the content selection module 235 selects content items for presentation to the user. As an additional example, the content selection module 235 selects content items having the highest scores or having at least a threshold score for presentation to the user. Alternatively, the content selection module 235 ranks content items based on their associated scores and selects content items having the highest positions in the ranking or having at least a threshold position in the ranking for presentation to the user.

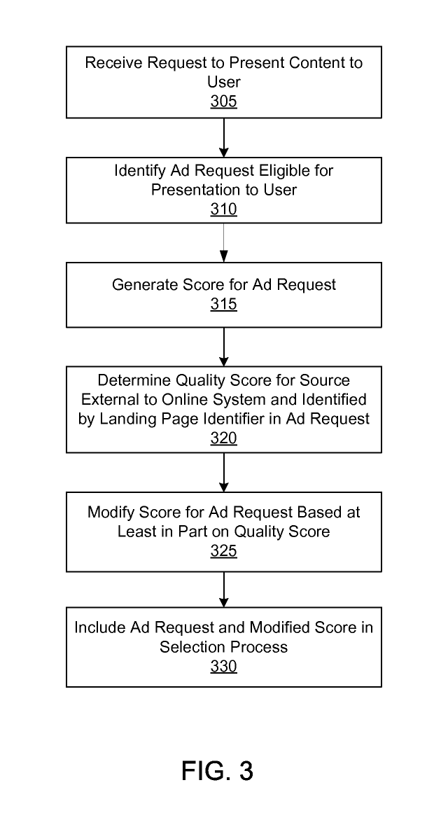

Content items eligible for presentation to the user may include ad requests or other content items associated with bid amounts. The content selection module 235 uses the bid amounts associated with ad requests when selecting content for presentation to the viewing user. In various embodiments, the content selection module 235 determines a score for various ad requests, or other content items, based at least in part on expected values associated with the ad requests determined from their bid amounts and selects content items associated with a maximum expected value or associated with at least a threshold expected value for presentation. An expected value associated with an ad request or with a content item represents an expected amount of compensation to the social networking system 140 for presenting an ad request or a content item. For example, the expected value associated with an ad request is a product of the ad request's bid amount and a likelihood of the user interacting with the ad content from the ad request. In some embodiments, a score for an ad request is also based on a likelihood of the user interacting with an advertisement in the ad request; for example, a conversion factor is applied to one or more of the expected value of the ad request or to the likelihood of the user interacting with the advertisement in the ad request to convert the likelihood of interaction and the expected value into a common unit of measurement, allowing combination of the expected value and the likelihood of user interacting with the ad request to generate the score for the ad request. As further described below in conjunction with FIG. 3, if an ad request includes an identifier of a landing page identifying a source external to the online system 140, the content selection module 235 may account for a quality score associated with the source external to the online system based on interactions by online system users with the source when determining a score for the ad request. The content selection module 235 may rank ad requests based on their associated scores and select ad requests having at least a threshold position in the ranking for presentation to the user. In some embodiments, the content selection module 235 ranks both content items not associated with bid amounts and ad requests in a unified ranking based on scores associated with content items and with ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content to a user of the social networking system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user. For example, information describing actions associated with other users connected to the user or other data associated with users connected to the user are retrieved. Additionally, one or more advertisement requests (“ad requests”) may be retrieved from the ad request store 230 The retrieved ad requests or content items, are analyzed by the content selection module 235 to identify candidate content items, including ad requests, eligible for presentation to the user. For example, content items associated with users who are not connected to the user or content items associated with users for whom the user has less than a threshold affinity are discarded as candidate content items. Based on various criteria, the content selection module 235 selects one or more of the content items or ad requests identified as candidate content for presentation to the identified user. The selected content items or advertisements from selected ad requests are included in a feed of content that is presented to the user. For example, the feed of content includes at least a threshold number of content items describing actions associated with users connected to the user via the social networking system 140.

In various embodiments, the content selection module 235 presents content to a user through a newsfeed including a plurality of content items selected for presentation to the user. One or more advertisements from ad requests may also be included in the feed. The content selection module 235 may also determine an order in which selected content items or advertisements are presented via the feed. For example, the content selection module 235 orders content items or advertisements in the feed based on likelihoods of the user interacting with various content items or advertisements.

The web server 240 links the online system 140 via the network 120 to the one or more client devices 110, as well as to the one or more third party systems 130. The web server 140 serves web pages, as well as other web-related content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS®, or BlackberryOS.

Accounting for Quality of an External Source Associated with an Advertisement Request when Scoring the Advertisement Request

FIG. 3 is a flowchart of one embodiment of a method for modifying a score of an advertisement request (“ad request”) based on a quality score of a source external to an online system associated with a landing page of the advertisement request. In some embodiments, the method may include different and/or additional steps than those described in conjunction with FIG. 3. Additionally, in some embodiments, the steps of the method may be performed in a different order than the order described in conjunction with FIG. 3.

The online system 140 receives advertisement requests (“ad requests”) from one or more advertisers (e.g., third party systems 130). As described above in conjunction with FIG. 2, each ad request includes a bid amount and an advertisement for presentation to a user. Additionally, an ad request may include an identifier of landing page identifying a source external to the online system 140 (e.g., a third party system 130). When the user interacts with the advertisement (e.g., selects the advertisements) included in the ad request, content from the landing page is retrieved and presented to the user. For example, an ad request includes an identifier of the landing page that is a network address, so content is retrieved from the network address and presented to the user when the user interacts with the advertisement from the ad request. In addition to receiving and maintaining ad requests, the online system 140 may retrieve ad requests maintained by third party systems 130.

When the online system 140 receives 305 a request from a user for content, the online system 140 identifies content eligible for presentation to the user. For example, the online system 140 receives 305 a request to refresh a feed of content presented to the user and identifies content eligible for presentation to the user. As another example, the online system 140 receives 305 a request to present a feed of content to the user and identifies content eligible for presentation to the user. Content eligible for presentation to the user may include ad requests and other content items. The online system 140 identifies 310 an ad request as eligible for presentation to the user if the ad request includes at least a threshold number of targeting criteria satisfied by characteristics of the user or if the ad request does not include targeting criteria. Similarly, the online system 140 identifies one or more content items as eligible for presentation to the user if the content items have at least a threshold number of characteristics, such as an association with another user or object connected to the user via the online system 140.

For an ad request identified 310 as eligible for presentation to the user that includes an identifier of a landing page identifying a source external to the online system 140, the online system 140 generates 315 a score for the ad request based at least in part on a likelihood of the user interacting with the advertisement from the ad request and on a bid amount included in the ad request, as further described above in conjunction with FIG. 2. If the ad request includes an identifier of landing page identifying a source external to the online system 140 (e.g., a third party system 130), the online system 140 determines 320 a quality score for the source external to the online system 140 based on interactions by online system users with content associated with the source external to the online system 140 and a frequency with which online system users access the source external to the online system 140 via the online system 140. For example, if the identifier of the landing page included in the ad request identifies a network address of a domain different than a domain of the online system 140, the online system 140 determines a quality score of the domain different than the domain of the online system 140. To determine 320 the quality score for the source external to the online system 140, the online system 140 retrieves stored actions of online system users and identifies a frequency with which online system users have accessed the source external to the online system 140 from the online system 140. For example, the online system 140 determines a number of times online system users have requested content from a domain of the source external to the online system 140 while interacting with the online system 140 within a time interval or determines an average frequency with which online system users have requested content from the domain of the source external to the online system 140 while interacting with the online system 140. In some embodiments, the online system 140 identifies a number of times users accessed links to the source external to the online system 140 that were presented by the online system 140 during a specific time interval. The online system 140 may identify a frequency with which the user requested content from the source external to the online system 140, a frequency with which additional users having at least a threshold number or percentage of characteristics matching characteristics of the user requested content from the source external to the online system 140, or a frequency with which by users of the online system 140 as a whole requested content from the source external to the online system 140.

Additionally, the online system 140 identifies one or more types of interactions by online system users with content associated with the source external to the online system 140 that was presented by the online system 140. For example, the online system 140 identifies types of interactions by users indicating an interest in content associated with the source that was presented by the online system 140. Example types of interactions indicating an interest in content associated with the source include: users expressing a preference for a content item presented by the online system 140 and associated with the source, users sharing a content item presented by the online system 140 and associated with the source with one or more additional users, users providing a comment associated with a content item associated with the source, and users establishing connections with one or more objects maintained by the online system 140 and associated with the source. Additionally, the online system 140 may identify types of interactions by various users indicating a lack of interest in content associated with the source, such as one or more users hiding content presented by the online system 140 and associated with the source. The online system 140 may identify different types of interactions with content associated with the source and presented by the online system 140 by the user, by additional users having at least a threshold number or percentage of characteristics matching characteristics of the user, or by users of the online system 140 as a whole. In some embodiments, the online system 140 may analyze content provided to the online system 140 by the user (or other users) that identifies the source using one or more sentiment analysis processes to identify the user's perception of the source and determine whether the user has in interest or a lack of interest in the source based on the user's perception of the source.

Based on the identified types of interactions and the frequency with which online system users access the source external to the online system 140 from the online system 140, the online system 140 determines 320 the quality score for the source external to the online system 140. In some embodiments, the online system 140 determines 320 the quality score for the source as a ratio of a value based on the identified types of interactions with content associated with the source external to the online system 140 by online system users to the frequency with which online system users access the source external to the online system 140 from the online system 140. For example, the online system 140 associates different weights with different types of interactions with content associated with the source that was presented by the online system 140 and generates the value by applying weights to numbers of the different types of interactions or to frequencies with which users perform the different types of interactions and combining the results from application of the weights. Types of interactions indicating an interest in the source may be associated with positive weights, while types of interactions indicating a lack of interest in the source may be associated with negative weights. Additionally, the online system 140 may associate a weight with a perception of the source from sentiment analysis of content identifying the source and provided to the online system 140 by one or more users and combine the weight associated with the perception of the source with the weighted number of occurrences of different types of identified interactions (or with the weighted frequencies with which different types of identified interactions occur). The online system 140 may modify the quality score for the source external to the online system 140 at periodic intervals to improve the accuracy of the quality score. Alternatively, the online system 140 determines 320 the quality score for the source external to the online system 140 when different ad requests including an identifier of a landing page identifying the source are identified as eligible for presentation to the user or are identified as eligible for presentation to other users of the online system 140.

Based on the quality score for the source external to the online system 140, the online system modifies 325 the score for the ad request eligible for presentation to the user that includes the identifier of the landing page identifying the source external to the online system 140. For example, if the quality score for the source equals or exceeds a threshold value, the online system 140 increases the score for the ad request. Similarly, if the quality score for the source is less than alternative threshold value, the online system 140 decreases the score for the ad request. In some embodiments, the online system 140 compares the quality score to various ranges, each associated with amounts by which to modify the score for the ad request, identifies a range including the quality score, and modifies 325 the score for the ad request by the amount associated with the identified range. Alternatively, the online system 140 modifies 325 the score by an amount that is a function of the quality score for the source (e.g., an amount that is proportional to the quality score for the source). In some embodiments, the online system 140 modifies 325 scores associated with multiple ad requests including an identifier of a landing page that identifies the source external to the online system 140 (e.g., each ad request including an identifier of a landing page within a domain of the source external to the online system 140). Alternatively, the online system 140 modifies 325 scores associated with additional ad requests including an identifier of a landing page identifying the source external to the online system 140 (e.g., ad requests including an identifier specifying a domain of the source external to the online system 140) and having a threshold number or a threshold percentage of characteristics matching characteristics of the ad request including the identifier of the landing page identifying the source.

In other embodiments, the online system 140 determines 320 the quality score for the source external to the online system 140 based on types of interactions by online system users with content associated with the source external to the online system 140 and presented by the online system 140 that indicate lack of interest in the source. In these embodiments, a larger quality score may indicate less interest in the source external to the online system 140, so the online system 140 decreases the score for the ad request if the quality score exceeds a threshold and increases the score for the ad request if the quality score is less than an alternative threshold. Similarly, in embodiments where a larger quality score indicates less interest in the source by online system users, the online system 140 may modify 325 the score by an amount that is an inverse function of the quality score for the source (e.g., an amount that is inversely proportional to the quality score for the source).

The online system 140 includes 330 the ad request eligible for presentation to the user and including the identifier of the landing page identifying the source external to the online system 140, along with its modified score, in one or more selection processes that select content for presentation to the user. A selection process may rank ad requests based on their associated scores and select ad requests having at least a threshold position in the ranking or selects ad requests having at least a threshold score for presentation to the user. The online system 140 includes advertisements from the selected ad requests in content that is communicated to a client device 110 associated with the user for presentation to the user. Using the modified score for the ad request in the selection process allows the online system 140 to account for the quality of content from the source external to the online system 140 when selecting content for presentation to the user. Hence, an ad request associated with a landing page identifying a source external to the online system 140 having a higher quality score is more likely to be selected for presentation to the user because the score for the ad request is increased based on the higher quality score. This improves user interaction with content selected by the online system 140, while increasing potential revenue to the online system 140 from presenting users with advertisements from ad requests associated with sources with which users are more likely to access by accessing the advertisements.

While FIG. 3 describes an embodiment where the quality score for the source external to the online system 140 is determined 320 after an ad request including an identifier of a landing page identifying the source external to the online system 140, in other embodiments, the online system 140 may determine whether the ad request includes the identifier of the landing page identifying the source external to the online system 140 when the ad request is received by the online system 140. If the online system 140 determines the ad request includes the identifier of the landing page identifying the source external to the online system 140 when the ad request is received by the online system 140, the online system 140 determines 320 the quality score for the source external to the online system 140, as described above in conjunction with FIG. 3, and associates the quality score with the ad request. If the online system 140 subsequently determines the ad request is eligible for presentation to the user, the online system 140 generates 315 a score for the ad request based on the quality score associated with the ad request, the bid amount included in the ad request, and the likelihood of the user interacting with the advertisement included in the ad request, as described above. The online system 140 subsequently includes 330 the ad request along with its score in one or more selection processes, as further described above.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request to present content to a user of the online system;
identifying an advertisement request (“ad request”) maintained by the online system eligible for presentation to the user, the ad request including a bid amount, an advertisement, and an identifier of a landing page identifying a source external to the online system;
generating a score for the ad request based at least in part on the bid amount included in the ad request and a likelihood of the user interacting with the advertisement included in the ad request;
determining a quality score for the source external to the online system based at least in part on interactions with content presented by the online system and associated with the source external to the online system by users of the online system and on a frequency with which users of the online system access the source external to the online system from the online system;
modifying the score for the ad request based at least in part on the quality score; and
including the ad request and the modified score for the ad request in a selection process that identifies content for presentation to the user.

2. The method of claim 1, wherein determining the quality score for the source external to the online system comprises:
identifying one or more types of interactions by users of the online system with content presented by the online system and associated with the source external to the online system that indicate an interest in the source external the online system; and
determining the quality score for the source external to the online system based at least in part on the identified one or more types of interactions and the frequency with which the users of the online system access the source external to the online system from the online system.

3. The method of claim 2, wherein determining the quality score for the source external to the online system based at least in part on the identified one or more types of interactions and the frequency with which the users of the online system access the source external to the online system from the online system comprises:
determining a ratio of a value based on the identified one or more types of interactions to the frequency with which the users of the online system access the source external to the online system from the online system.

4. The method of claim 3, wherein determining the ratio of the value based on the identified one or more types of interactions to the frequency with which the users of the online system access the source external to the online system from the online system comprises:
identifying a number of each identified type of interaction;
applying weights to the identified numbers of each identified type of interaction, a weight associated with an identified type of interaction applied to the number of the identified type of interaction; and
determining the value as a combination of the identified numbers of each identified type of interaction after application of the weights.

5. The method of claim 2, wherein one or more types of interactions by users of the online system with content presented by the online system and associated with the source external to the online system that indicate an interest in the source external the online system are selected from a group consisting of: one or more users of the online system expressing a preference for one or more content items associated with the source external to the online system, one or more users of the online system sharing one or more content items associated with the source external to the online system with additional users of the online system, one or more users of the online system providing a comment associated with one or more content items associated with the source external to the online system, and any combination thereof.

6. The method of claim 1, wherein determining the quality score for the source external to the online system comprises:
identifying one or more types of interactions by users of the online system with content presented by the online system and associated with the source external to the online system that indicate an interest in the source external the online system;
identifying one or more additional types of interactions by users of the online system with content presented by the online system and associated with the source external to the online system that indicate a lack of interest in the source external the online system
determining the quality score for the source external to the online system based at least in part on the identified one or more types of interactions, the identified one or more additional types of interactions, and the frequency with which the users of the online system access the source external to the online system from the online system.

7. The method of claim 1, wherein modifying the score for the ad request based at least in part on the quality score comprises:
increasing the score for the ad request in response to the score equaling or exceeding a threshold value; and
decreasing the score for the ad request in response to the score being less than an alternative threshold value.

8. The method of claim 1, wherein modifying the score for the ad request based at least in part on the quality score comprises:
comparing the quality score to a plurality of ranges, each range associated with an amount; and
modifying the score for the ad request by an amount associated with a range including the quality score.

9. The method of claim 1, wherein modifying the score for the ad request based at least in part on the quality score comprises:
modifying the score for the ad request by an amount that is a function of the quality score.

10. The method of claim 1, further comprising:
modifying scores associated with one or more additional ad requests including identifiers of one or more landing pages identifying the source external to the online system based at least in part on the quality score.

11. The method of claim 1, wherein the source external to the online system comprises a source associated with a domain differing from a domain associated with the online system.

12. A method comprising:
identifying an advertisement request (“ad request”) maintained by the online system including a bid amount, an advertisement, and an identifier of a landing page identifying a source external to the online system;
determining a quality score for the source external to the online system based at least in part on interactions with content associated with the source external to the online system by users of the online system and on a frequency with which users of the online system access the source external to the online system from the online system;
associating the quality score with the ad request;
determining the ad request is eligible for presentation to a user of the online system;
generating a score for the ad request based at least in part on the quality score, the bid amount included in the ad request, and a likelihood of the user interacting with the advertisement included in the ad request; and
including the ad request and the score for the ad request in a selection process that identifies content for presentation to the user.

13. The method of claim 12, wherein determining the quality score for the source external to the online system comprises:
identifying one or more types of interactions by users of the online system with content presented by the online system and associated with the source external to the online system that indicate an interest in the source external the online system; and
determining the quality score for the source external to the online system based at least in part on the identified one or more types of interactions and the frequency with which the users of the online system access the source external to the online system from the online system.

14. The method of claim 13, wherein determining the quality score for the source external to the online system based at least in part on the identified one or more types of interactions and the frequency with which the users of the online system access the source external to the online system from the online system comprises:
determining a ratio of a value based on the identified one or more types of interactions to the frequency with which the users of the online system access the source external to the online system from the online system.

15. The method of claim 14, wherein determining the ratio of the value based on the identified one or more types of interactions to the frequency with which the users of the online system access the source external to the online system from the online system comprises:
identifying a number of each identified type of interaction;
applying weights to the identified numbers of each identified type of interaction, a weight associated with an identified type of interaction applied to the number of the identified type of interaction; and
determining the value as a combination of the identified numbers of each identified type of interaction after application of the weights.

16. The method of claim 14, wherein one or more types of interactions by users of the online system with content presented by the online system and associated with the source external to the online system that indicate an interest in the source external the online system are selected from a group consisting of: one or more users of the online system expressing a preference for one or more content items associated with the source external to the online system, one or more users of the online system sharing one or more content items associated with the source external to the online system with additional users of the online system, one or more users of the online system providing a comment associated with one or more content items associated with the source external to the online system, and any combination thereof.

17. A computer program product comprising a computer-readable storage medium having instructions encoded thereon that, when executed by a processor, cause the processor to:
receive a request to present content to a user of the online system;
identify an advertisement request (“ad request”) maintained by the online system eligible for presentation to the user, the ad request including a bid amount, an advertisement, and an identifier of a landing page identifying a source external to the online system;
generate a score for the ad request based at least in part on the bid amount included in the ad request and a likelihood of the user interacting with the advertisement included in the ad request;
determine a quality score for the source external to the online system based at least in part on interactions with content presented by the online system and associated with the source external to the online system by users of the online system and on a frequency with which users of the online system access the source external to the online system from the online system;
modify the score for the ad request based at least in part on the quality score; and
include the ad request and the modified score for the ad request in a selection process that identifies content for presentation to the user.

18. The computer program product of claim 17, wherein determine the quality score for the source external to the online system comprises:
identify one or more types of interactions by users of the online system with content presented by the online system and associated with the source external to the online system that indicate an interest in the source external the online system; and
determine the quality score for the source external to the online system based at least in part on the identified one or more types of interactions and the frequency with which the users of the online system access the source external to the online system from the online system.

19. The computer program product of claim 18, wherein one or more types of interactions by users of the online system with content presented by the online system and associated with the source external to the online system that indicate an interest in the source external the online system are selected from a group consisting of: one or more users of the online system expressing a preference for one or more content items associated with the source external to the online system, one or more users of the online system sharing one or more content items associated with the source external to the online system with additional users of the online system, one or more users of the online system providing a comment associated with one or more content items associated with the source external to the online system, and any combination thereof.

20. The computer program product of claim 17, wherein the computer-readable storage medium further has instructions encoded thereon that, when executed by the processor, cause the processor to:
modify scores associated with one or more additional ad requests including identifiers of one or more landing pages identifying the source external to the online system based at least in part on the quality score.
